(19) United States
(12) Patent Application Publication
(10) Pub. No.: US 2011/0111711 A1
(43) Pub. Date: May 12, 2011

(54) High Efficiency Linear Transmitter

(75) Inventor: Shi Bo, Singapore (SG)

(73) Assignee: AGENCY FOR SCIENCE, TECHNOLOGY AND RESEARCH, Singapore (SG)

(21) Appl. No.: 12/935,907

(22) PCT Filed: Mar. 31, 2009
(86) PCT No.: PCT/SG2009/000111

§ 371 Date: Dec. 19, 2010

Related U.S. Application Data
(60) Provisional application No. 61/040,769, filed on Mar. 31, 2008.

(51) Int. Cl. H04B 1/04

(52) U.S. Cl. 455/127.1

(57) ABSTRACT

A highly efficient linear transmitter uses a control module to compare an input signal with a threshold. The transmitter includes one or more power amplifiers (230a, 230b), a component separator (210b) and a combiner (240). The power amplifiers are coupled to a first power supply voltage (V_{d}) and a second power supply voltage (V_{d}/β. Above the threshold the input signal is applied directly to the separator and a first power supply voltage is selected for the power amplifiers. When the input signal is below the threshold the input to the separator is multiplied by a factor β and the power amplifiers are compensated by applying a second power supply voltage (V_{d}/β. Components include LINC (constant amplitude variable phase) signals.

### TECHNICAL FIELD

The present disclosure generally relates to transmitters. More particularly, various aspects of the present disclosure relate to high efficiency linear transmitters.

### BACKGROUND

Achieving spectral efficiency is an important issue for wireless communications, since the available Radio Frequency (RF) spectrum is a limited natural resource. Spectrum efficient linear modulation schemes with varying signal amplitude have been used in new generations of wireless systems, such as 3G based systems, Wireless Local Area Network (WLAN) based systems, and Worldwide Inter-operability for Microwave Access (WiMAX) based systems.

The ongoing demand for cost reduction has resulted in the evolution of basic base station systems into multi-carrier type base station systems. In multi-carrier type base station systems, RF carriers with fluctuating envelopes are combined to form a composite source signal. Such combination of multiple RF carriers causes the peak-to-average ratio (PAR) of the composite source signal to increase, thereby enhancing the need for distortion-free amplification. Without distortion-free amplification, the spectral properties of the composite source signal will deteriorate due to inter-modulation distortion (IMD), which may cause interference for users in adjacent channels of the spectrum. Distortion-free amplification is typically achieved through the use of a linear transmitter and a linear RF power amplifier (PA).

Both linearity and efficiency are issues of concern during wireless transmission. Typically, linearity of RF amplification is achieved either by reducing power efficiency or using linearization techniques. For example, the linearity of linear PAs, such as class-A PAs and class-AB PAs, can be improved by reducing the level of input signals. However by reducing the level of input signals, there is a need for the PA to operate in high linearity power region. Consequently higher saturation power, than is normally required, is needed to operate the PA. Hence power consumption of the PA may be increased to operate the PA in high linearity power region.

When factors such as an increasing number of base stations and mobile device battery power limitations are taken into consideration, increased power consumption is not desired. To overcome the problem of increased power consumption during linear amplification, the use of a linear RF PA may be replaced by the use of a nonlinear high efficiency PA. Over its intended power range, the nonlinear response of a nonlinear high efficiency PA can be made linear through the use of amplifier linearization techniques. One such amplifier linearization technique is known as Linear Amplification with Nonlinear Components (LINC).

FIG. 1a shows a conventional LINC transmitter 100. The conventional LINC transmitter 100 includes a Signal Component Separator (SCS) 110, a first power amplifier 120a, a second power amplifier 120b and a combiner 130. The SCS 110 receives an input signal (not shown) and transforms the input signal to two signal components (not shown). Each of the first and second power amplifiers 120a/120b has an input and an output that are coupled to the SCS 110 and the combiner 130, respectively. Each of the two signal components are provided to the corresponding first and second power amplifiers 120a/120b and amplified, before being provided to the combiner 130. The combiner 130 receives the amplified signal components and combines them to produce an output signal (not shown).

The overall efficiency of the conventional LINC transmitter 100 depends upon the power efficiency of the first and second power amplifiers 120a/120b, the efficiency of the combiner 130 itself, and the efficiency of the signal recombining process. By operating each of the first and second power amplifiers 120a/120b in class E or class F switching mode, the power efficiency of the first and second power amplifiers 120a/120b can be maximized for an input signal that has a constant envelope. Under such operating conditions, the efficiency of the LINC transmitter 100 is critically dependent upon the type of the combiner, since it determines the recombining efficiency.

Two types of combiners are conventionally employed, namely, a matched hybrid combiner or an unmatched lossless combiner. The hybrid combiner is a matched and lossy combiner with high isolation between the amplified signal components. If a hybrid combiner is used in the LINC transmitter 100, the linearity of the output signal can be improved. This is due to the isolation between the amplified signal components. However, the recombining efficiency with the hybrid combiner is low because part of the amplified signal components' energy is combined out of phase and dissipated as heat energy in a passive load (not shown).

On the other hand, the unmatched lossless combiner does not provide isolation between the combined paths, and introduces significant interaction between the first and second power amplifiers 120a/120b. Therefore, the unmatched lossless combiner is more efficient than the hybrid combiner, as the outputs of each of the first and second power amplifiers 120a/120b are coupled. This output coupling results in the provision of time varying loads to the outputs of first and second power amplifiers 120a/120b as the phase difference between each of the component signals varies. The efficiency and linearity of the LINC transmitter 100 therefore depends on how each of the first and second power amplifiers 120a/120b responds to the time varying load.

For example, if each of the first and second power amplifiers 120a/120b behaves similarly to ideal voltage sources, the power consumption will be directly proportional to the load impedance. Therefore, the efficiency of the LINC transmitter 100 in such an ideal situation remains high at all output levels.

However, due to limitations in device technology, the use of the unmatched lossless combiner may significantly degrade the linearity of the LINC transmitter 100. One such device technology limitation arises because each of the first and second power amplifiers 120a/120b does not behave as an ideal voltage source, especially at high frequencies in the gigahertz (GHZ) frequency range. Therefore, due to linearity considerations, the hybrid combiner is typically used in the LINC transmitter 100.

When a hybrid combiner is used in the LINC transmitter 100, full signal dynamics must be reproduced. This is achieved when the first and second power amplifiers 120a/120b continuously generate a maximum output. Therefore, a constant amount of Direct Current (DC) power is required and consumed by the LINC transmitter 100, even when the combined instantaneous output power from the first and second power amplifiers 120a/120b is zero.

Therefore, although the first and second power amplifiers 120a/120b are able to operate with high power efficiency, DC power consumption by the LINC transmitter 100 is substantial when the amplified signal components are generated at maximum output power and are out of phase with respect to each other. Consequently, the recombining efficiency of the LINC transmitter 100 is adversely affected.

It is therefore desirable to provide a solution for addressing at least one of the foregoing problems of the conventional LINC transmitter 100.

### SUMMARY

In accordance with an aspect of the invention, a signal transmitter is provided. The signal transmitter comprises a control module, a signal component separator module, a power amplifier module and a signal combiner. The control module has a first input coupled to receive an input signal, a second input coupled to receive a threshold signal, and an output configured to provide a control signal. The signal component separator has a first input coupled to receive the input signal and a second input coupled to receive the control signal. The signal component separator also has a first output configured to provide a first signal component and a second output configured to provide a second signal component. The power amplifier module has a first input coupled to the first output of the signal component separator module, a second input coupled to the second output of the signal component separator module, a control input coupled to the output of the control module, a first output and a second output. The power amplifier module also has a first circuit portion coupled to a first power supply voltage and a second circuit portion coupled to a second power supply voltage. The signal combiner has a first input coupled to the first power amplification module output, a second input coupled to the second power amplifier module output, and an output configured to provide a recombined output signal.

In accordance with another aspect of the invention, a signal transmitter is provided. The signal transmitter comprises a comparator, a signal component separation module, a power amplifier module and a signal combiner. The comparator has a first input coupled to receive an input signal, a second input coupled to receive a threshold signal, and an output. The signal component separation module has a first input coupled to receive the input signal, a second input coupled to the output of the comparator, a first output and a second output. The power amplifier module has a first input and a second input respectively coupled to the first and second signal component separator outputs, a control input coupled to the output of the comparator, a first output and a second output. The signal combiner has a first input and a second input respectively coupled to the first and second power amplifier module outputs, and an output.

In accordance with yet another aspect of the invention, a signal transmission method is provided. The signal transmission method comprises determining whether an input signal amplitude corresponds to a low power condition and selectively up-scaling the input signal amplitude based upon whether the input signal corresponds to a low power condition. The signal transmission method also comprises performing a signal component separation upon the selectively up-scaled input signal to generate a first signal component and a second signal component. The signal transmission method further comprises amplifying at least the first signal component, selectively compensating for the selective up-scaling of the input signal amplitude and generating a recombined output signal.

### BRIEF DESCRIPTION OF THE DRAWINGS

Particular embodiments of the disclosure are described hereinafter with reference to the following drawings, in which:

FIG. 1a shows a conventional Linear amplification with Nonlinear Components (LINC) transmitter including a Signal Component Separator, a first power amplifier, a second power amplifier and a combiner;

FIG. 1b is a table of calculated total recombining efficiency values corresponding to a conventional LINC transmitter operating in accordance with several typical modulation and filtering combinations;

FIG. 2a shows a linear transmitter including an input module, a converter module, an amplifier module and a combiner, in accordance with an embodiment of the disclosure;

FIG. 2b is a table of calculated total recombining efficiency values for a conventional LINC transmitter and a linear transmitter according to an embodiment of the disclosure, each operating in accordance with particular typical modulation and filtering combinations;

FIG. 3 shows a simulated output spectrum at the amplifier module and the combiner output of the linear transmitter of FIG. 2, using a 64-QAM signal as an input signal; and

FIG. 4 is a flow diagram of a signal transmission process according to an embodiment of the disclosure.

### DETAILED DESCRIPTION

Various embodiments of the present disclosure are directed to a high efficiency linear transmitter that can be used in applications such as wireless products involving high linearity Radio Frequency (RF) power amplification. Examples of such wireless products include 3G mobile phones, 4G mobile phones, wireless local area network (WLAN) devices and multiple-input and multiple-output (MIMO) WLAN devices. Further examples include software-defined radios and cognitive radios. Additionally or alternatively, the linear transmitter can be used in base stations.

For purposes of brevity and clarity, aspects of various embodiments of the disclosure are described herein in the context of a linear transmitter. This, however, does not preclude the applicability of various embodiments to other systems, devices, and/or processes where the fundamental principles prevalent among the various embodiments of the disclosure, such as operational, functional or performance characteristics, are desired.

As further detailed below, an overall or total recombining efficiency ηₜₒₜ, for a LINC amplifier can be defined as a product of 1) a power amplifier efficiency ηₐ; 2) a combiner efficiency η_{c} representing signal loss in the combiner itself; and 3) a signal recombining process efficiency ηₘ, which depends upon input signal power or magnitude.

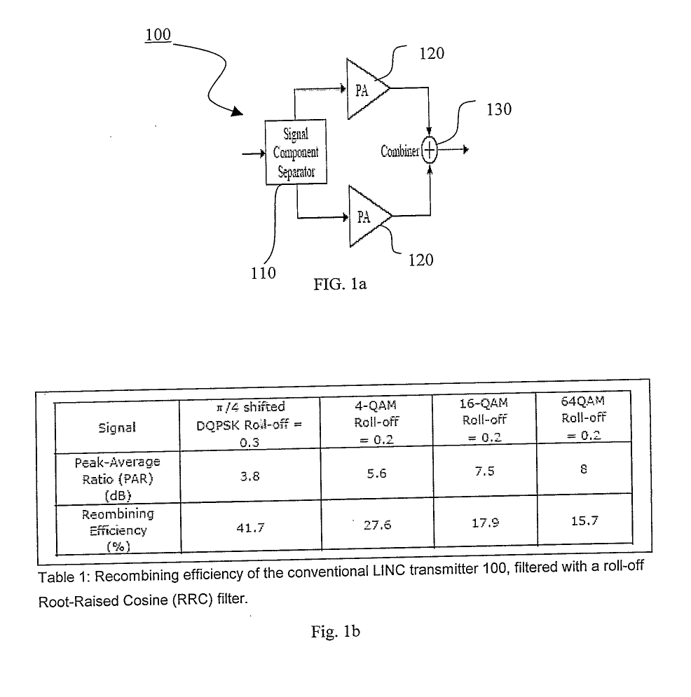

FIG. 1b is a table illustrating representative total recombining efficiency ηₜₒₜ values calculated for a set of conventional LINC transmitters operating in accordance with several typical modulation schemes and a square root raised cosine filtering condition. In FIG. 1b, the power amplifier efficiency ηₐ and the combiner efficiency η_{c} are defined to be one hundred percent (100%), such that the efficiency values shown correspond only to the signal recombining process efficiency ηₘ.

The values shown in FIG. 1b indicate that the total recombining efficiency ηₜₒₜ of a LINC transmitter depends upon the magnitude or power of the modulated input signal. More particularly, the total recombining efficiency ηₜₒₜ depends upon signal PAR. Still more particularly, total recombining efficiency ηₜₒₜ decreases as signal PAR increases. Considering one general situation, input signals that have been subjected to high order modulations will exhibit large or expanded signal PAR, and reduced or low input average signal power. Such high order modulations result in the generation of out of phase amplified signal components at a LINC transmitter's power amplifiers, adversely impacting signal recombination process efficiency ηₘ.

As described in detail below, various embodiments of the disclosure increase total system efficiency by reducing or selectively reducing signal PAR.

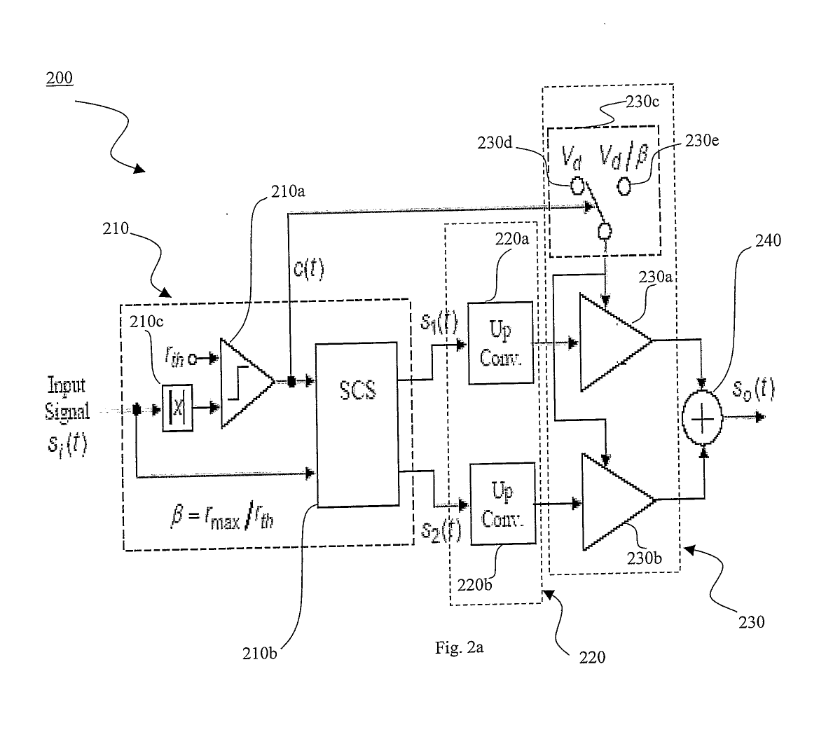

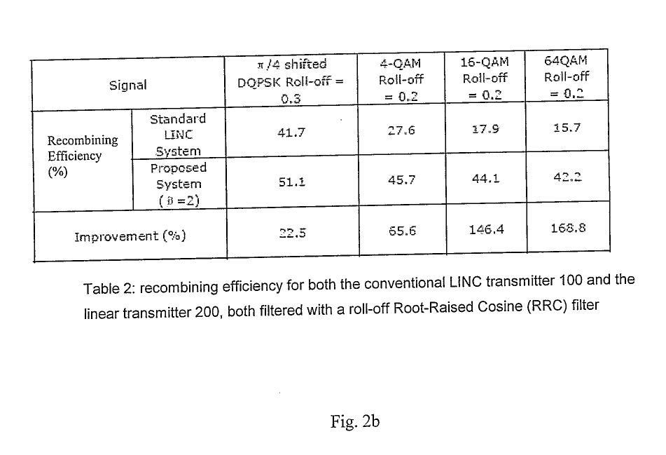

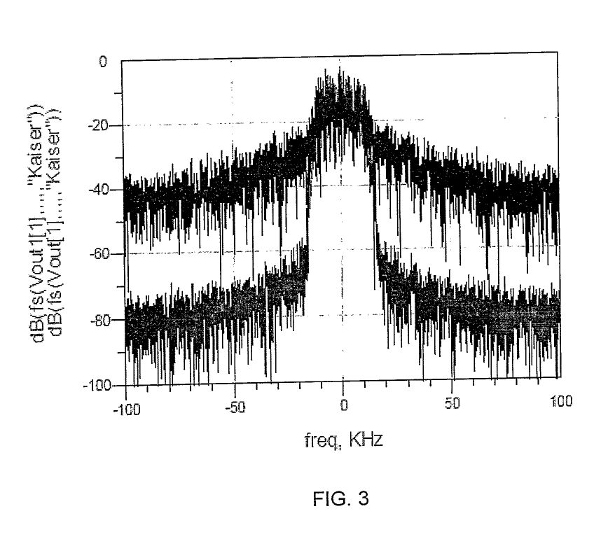

In accordance with a representative embodiment of the disclosure, a linear transmitter 200 for addressing various problems associated with conventional LINC transmitters, such as one or more problems indicated above, is described hereinafter with reference to FIGS. 2-3. An overview of an embodiment of a linear transmitter 200 is provided with respect to FIG. 2, and representative operation of such a linear transmitter 200 is thereinafter discussed.

As shown in FIG. 2, a linear transmitter 200 according to particular embodiments of the disclosure includes an input module 210, an amplifier module 230 and a combiner 240. In some embodiments, the linear transmitter 200 further includes a converter module 220. The input module 210 can be implemented using a Digital Signal Processor (DSP), and includes a comparator 210a, a Signal Component Separator (SCS) module 210b and an amplitude detector 210c. The converter module 220 includes a first up-converter module 220a and a second up-converter module 220b. The amplifier module 230 includes a first power amplifier 230a, a second power amplifier 230b and a power switch module 230c that switches between, for example, a first power supply 230d and a second power supply 230e. In various embodiments, the first and second power supplies 230d/230e provide supply voltages having different voltage amplitudes. For example, the first power supply 230d can provide a supply voltage having a first voltage amplitude V_{d} and the second power supply 230e can provide another supply voltage having a second voltage amplitude V_{d}/β.

The input module 210 receives input signal Sᵢ(t), which is provided to the amplitude detector 210c and the SCS module 210b. The amplitude detector 210c detects the amplitude of input signal Sᵢ(t) and determines magnitude /X/ of input signal Sᵢ(t). The comparator 210a is provided with a selected threshold signal rₜₕ and the magnitude /X/ of input signal Sᵢ(t). The comparator 210a compares magnitude /X/of input signal Sᵢ(t) and the selected threshold signal, and generates a control signal C(t).

The SCS module 210b receives the input signal Sᵢ(t) and the control signal C(t). The input signal Sᵢ(t) is subsequently transformed by the SCS module 210b to a first signal component S₁(t) and a second signal component S₂(t), which can be provided to the first and second up-converter modules 220a/220b, respectively. The first and second signal components S₁(t)/S₂(t) can then be provided to the first and second power amplifiers 230a/230b, respectively, of the amplifier module 230.

The first and second up-converter modules 220a/220b serve to modulate the first and second signal components S₁(t)/S₂(t) with a high carrier frequency if a high frequency input to each of the respective first and second power amplifiers 230a/230b is desired (e.g., when signal components generated at baseband are to be translated to an RF carrier frequency for radio transmission). Alternatively, the first and second signal components S₁(t)/S₂(t) can be provided directly to the respective first and second power amplifiers 230a/230b without being modulated by the first and second up-converter modules 220a/220b if the first and second signal components are directly generated at a desired carrier frequency.

The first and second power amplifiers 230a/230b provide gain, denoted by symbol ‘G’, to each of the respective first and second signal components S₁(t)/S₂(t), thus amplifying each of the first and second signal components S₁(t)/S₂(t). The amplified first and second signal components S₁(t)/S₂(t) are subsequently provided to the combiner 240 and recombined to obtain a recombined output signal Sₒ(t). The combiner 240 can be, for example, a matched hybrid combiner.

The power switch module 230c receives the control signal C(t), which controls the power switch module 230c for determining the voltage amplitude provided to each of the first and second power amplifiers 230a/230b. For example, the control signal C(t) controls the power switch module 230c, which is switchable between the first or second power supplies 230d/230e for supplying either a supply voltage having the first voltage amplitude V_{d} or another supply voltage having the second voltage amplitude V_{d}/β to the first power amplifier 230a and the second power amplifier 236b.

Each of the first and second power amplifiers 230a/230b can be a switching amplifier and is generally a highly nonlinear but power efficient amplifier. Examples of each of the first and second power amplifiers 230a/230b include a class D, a class E and a class F amplifier, where output power is proportional to the square of the voltage amplitude of supply voltage supplied and power efficiency is ideally one hundred percent (100%). Additionally, the performance, such as power efficiency, of a switching amplifier is substantially unaffected by variance of the amplitude of the supply voltage provided to the switching amplifier.

Representative operation of a linear transmitter according to an embodiment of the disclosure, such as the linear transmitter 200 shown in FIG. 2, is described hereinafter.

An input signal Sᵢ(t) can be, for example, a general baseband band limited source signal, which can be represented by first equation (1) as follows,

sⱼ(t)=r(t)e^{jφ(t)}; 0≦r(t)≦rₘₐₓ (1)

Each of the first and second signal components S₁(t)/S₂(t) can be represented by second equations (2) as follows, with rₘₐₓ denoting a maximum amplitude level; φ(t) with α(t) denoting the instantaneous phase of each of the first and second signal components S₁(t)/S₂(t); and r(t) denoting an instantaneous amplitude level.

$$\begin{matrix}{s}_{1} ( t ) = {r}_{max} {e}^{j [ φ ( t ) + α ( t ) ]} \\ {s}_{2} ( t ) = {r}_{max} {e}^{j [ φ ( t ) - α ( t ) ]} & ( 2 ) \\ \begin{matrix}α ( t ) = {cos}^{- 1} [ \frac{r ( t )}{{r}_{max}} ] , & if r ( t ) > {t}_{th}\end{matrix} \\ \begin{matrix}α ( t ) = {cos}^{- 1} [ \frac{r ( t )}{{r}_{th}} ] = {cos}^{- 1} [ β \frac{r ( t )}{{r}_{max}} ] , & if r ( t ) \leq {t}_{th}\end{matrix} & ( 3 )\end{matrix}$$

The first and second signal components S₁(t)/S₂(t) are out-of-phase after transformation by the SCS 210b. Furthermore, since each of the first and second signal components S₁(t)/S₂(t) has constant amplitude, which is the maximum amplitude level rₘₐₓ, they can be amplified individually by the first and second power amplifiers 230a/230b, respectively.

In various embodiments, as represented by third equations (3) above, if the input signal Sᵢ(t) has a magnitude or power level that is below a given (e.g., predetermined) reference or threshold signal level rₜₕ which can be defined as a minimum acceptable signal level, the input signal Sᵢ(t) is multiplied by a fixed scaling factor or ratio, denoted by symbol ‘β’. Otherwise, the input signal is not subjected to multiplication by the ratio β. In other words, if the input signal Sᵢ(t) has an amplitude that is below the threshold signal level rₜₕ, the amplitude of the input signal Sᵢ(t) is up-scaled by the factor β. Alternatively, when the input signal Sᵢ(t) exhibits an adequate, appropriate, or high power level (e.g., its magnitude is greater than or equal to rₜₕ), the input signal can be subjected to a multiplication in which β=1.

As shown in third equations (3), if the instantaneous amplitude level r(t), which determines the magnitude /X/ of the input signal Sᵢ(t), is less than or equal to the selected threshold signal level rₜₕ, it can be determined that the input signal Sᵢ(t) is a low power input signal. Otherwise, the input signal Sᵢ(t) is not defined as or determined to be a low power input signal, and is hence not subjected to multiplication with the ratio β. In several embodiments, third equations (3) can be implemented in the SCS module 210b of the input module 210.

In several embodiments, the fixed ratio β is determined such that the instantaneous amplitude level r(t) of each of the first and second signal components S₁(t)/S₂(t) is subsequently boosted to its maximum amplitude level rₘₐₓ if the input signal Sᵢ(t) has a low power level. Therefore, the fixed ratio β can be determined by fourth equation (4) as follows:

β=rₘₐₓ/rₜₕ (4)

The value of the selected threshold signal rₜₕ can be optimized based on signal amplitude distribution, otherwise known as signal probability density function Pₛ(r), which is dependent on the type of modulation scheme and type of filtering used. The average power r̅²̅ of the input signal Sᵢ(t) is represented by fifth equation (5) as follows:

r̅²̅=∫₀^{max}pₛ(r)r²dr (5)

Based on the average power r̅²̅ of the input signal Sᵢ(t) which is represented by fifth equation (5) above and the maximum amplitude level rₘₐₓ, the recombining efficiency ηₘ of the linear transmitter 200 is represented by sixth equation (6) as follows:

$${η}_{m} = \frac{\overline{{r}^{2}}}{{r}_{max}^{2}} \qquad ( 6 )$$

For purposes of illustration, it can be assumed that the first and second power amplifiers 230a/230b have unity gain (G=1). Therefore the symbol ‘(rₘₐₓ)²’ in the sixth equation (6) denotes maximum power which is produced at the output of any one of the first and second power amplifiers 230a/230b.

However, where the first and second power amplifiers 230a/230b do not have unity gain (G≠1), the symbol ‘(rₘₐₓ)²’ in the sixth equation (6) denotes peak power of the input signal Sᵢ(t). Where the first and second power amplifiers 230a/230b do not have unity gain (G≠1), the gain ‘G’ provided to the average power r̅²̅ of the input signal Sᵢ(t) is compensated by the gain ‘G’ provided to the peak power ‘(rₘₐₓ)²’ of the input signal Sᵢ(t).

Therefore regardless of whether the first and second power amplifiers 230a/230b have unity gain or not, the recombining efficiency ηₘ of the linear transmitter 200 can represented by sixth equation (6) as shown above.

The sixth equation (6) applies to a conventional LINC transmitter as well as a signal transmitter constructed in accordance with an embodiment of the disclosure. The key difference, however, is that for a conventional LINC transmitter, the useful average signal power is given by the fifth equation (5), whereas for a signal transmitter according to various embodiments of the disclosure the useful average signal power is given by a seventh equation (7) described hereafter.

After the input signal Sᵢ(t) has been processed, the processed input signal Sᵢ(t) has an average power P̅²̅, which can be represented by seventh equation (7) as follows, in which symbol ‘pₛ(r)’ denotes the probability density of the input signal Sᵢ(t).

$$\overline{{P}^{2}} = {\int }_{{r}_{th}}^{{r}_{max}} {p}_{s} ( r ) {r}^{2} d r + {\int }_{0}^{{r}_{th}} {p}_{s} ( r ) {( \frac{{r}_{max}}{{r}_{th}} r )}^{2} d r \qquad ( 7 )$$

Where the fixed ratio β of the fourth equation (4) is larger than numerical value one, the average power P̅²̅ of the input signal Sᵢ(t) after processing is larger than the average power r̅²̅ of the input signal Sᵢ(t). For optimized recombining efficiency ηₘ of the linear transmitter 200, the average power P̅²̅ of the input signal Sᵢ(t) after processing should be optimized by optimizing the value of the selected threshold signal rₜₕ which in various embodiments can be predetermined by performing simulating operations using or corresponding to the seventh equation (7) above.

Therefore, when the input signal Sᵢ(t) is a low power input signal, the PAR of the low power input signal can be reduced by multiplying the low power input signal by the fixed ratio β (e.g., at the input module 210). With this reduction of the PAR of the low power input signal, power wastage during recombination of the amplified first and second signal components S₁(t)/S₂(t), to obtain the recombined output signal Sₒ(t), is reduced. Therefore, the recombining efficiency ηₘ of the linear transmitter 200 is improved.

The recombining efficiency ηₘ, of the linear transmitter 200 together with the combiner efficiency η_{c} of the combiner 240 and the power efficiency ηₚ of each the first and second power amplifiers 230a/230b determines overall efficiency ηₜₒₜ of the linear transmitter 200. Hence, the overall efficiency ηₜₒₜ of the linear transmitter 200 is improved when the recombining efficiency ηₘ of the transmitter 200 is improved and the power efficiency ηₐ of each of the first and second power amplifiers 230a/230b and the combiner efficiency η_{c} of the combiner 240 remain constant. The overall efficiency ηₜₒₜ of the linear transmitter 200 can be represented by eighth equation (8) as follows:

ηₜₒₜ=ηₐ·η_{c}·ηₘ (8)

The recombined output signal Sₒ(t) can be represented by ninth equations (9) as follows,

$${s}_{o} ( t ) = \{ \begin{matrix}{Gs}_{1} ( t ) - {Gs}_{2} ( t ) = 2 Gr ( t ) {e}^{jφ ( t )} = 2 {Gs}_{i} ( t ) , & r ( t ) > {r}_{th} \\ {Gs}_{1} ( t ) + {Gs}_{2} ( t ) = 2 Gr ( t ) {e}^{jφ ( t )} \frac{{r}_{max}}{{r}_{th}} = 2 G β {s}_{i} ( t ) , & r ( t ) \leq {r}_{th}\end{matrix} \qquad ( 9 )$$

As shown in ninth equations (9), the fixed ratio β is a factor in the recombined output signal Sₒ(t) if the input signal Sᵢ(t) is a low power input signal. The fixed ratio 13 factor in the recombined output signal Sₒ(t) may result in distortion of the recombined output signal Sₒ(t). Therefore, there can generally be a need to compensate for the fixed ratio β factor, if present, in the recombined output signal Sₒ(t).

Compensation for the fixed ratio β factor can be achieved by reducing the amplitude of the recombined output signal Sₒ(t) by a compensation factor 1/β, which is inversely proportional to the fixed ratio factor.

In one embodiment, reduction of the amplitude of the recombined output signal Sₒ(t) can be achieved by appropriate control, by the control signal C(t), of the voltage amplitude of the supply voltage provided to each of the first and second power amplifiers 230a/230b via the power switch module 230c.

For example, when the fixed ratio β is not a factor or is not present in the recombined output signal Sₒ(t), reduction of the amplitude of the recombined output signal Sₒ(t) is not necessary. Therefore, a supply voltage having the first voltage amplitude V_{d} can be provided to the first and second power amplifiers 230a/230b via the power switch module 230c. However, if the fixed ratio β is a factor in the recombined output signal Sₒ(t), another supply voltage having the second voltage amplitude V_{d}/β is provided to the first and second power amplifiers 230a/230b via the power switch module 230c, thus reducing the amplitude of the recombined output signal Sₒ(t) by the compensation factor 1/β.

By appropriate control of the voltage amplitude of the supply voltage provided to each of the first and second power amplifiers 230a/230b via the power switch module 230c, for the above purpose of compensating the fixed ratio β factor in the recombined output signal Sₒ(t), the risk of encountering significant loss in the recombining efficiency of the linear transmitter 200 is mitigated. This is particularly so during amplification of each of the first and second signal components S₁(t)/S₂(t) by the first and second power amplifiers 230a/230b, and during recombination of the amplified first and second signal components S₁(t)/S₂(t) by the combiner 240 to obtain a recombined output signal Sₒ(t).

Alternatively, reduction of the amplitude of the recombined output signal Sₒ(t) is achieved by controlling total output power of the amplifier module 230 via appropriate control, by the control signal C(t). More specifically, the amplifier module 230 comprises a plurality of power amplifiers (not shown), all of which are preferably optimized to operate at maximum power efficiency and are supplied with the same supply voltage. Each of the plurality of power amplifiers are controllable by the control signal C(t) such that any one or more of the plurality of power amplifiers can be turned ‘on’ or ‘off’. Therefore the total output power of the amplifier module 230 is determined by a collective total of the output power of the power amplifiers which are turned ‘on’ by the control signal C(t). Since each of the plurality of power amplifiers are optimized to operate at maximum power efficiency, reduction of the amplitude of the recombined output signal Sₒ(t) is achieved without affecting power efficiency of the amplifier module 230.

For example, the amplifier module 230 comprises ten power amplifiers, each of which generates a hundred milliwatts (100 mW) output power. If all the ten power amplifier are turned ‘on’ by the control signal C(t), the total output power of the amplifier 230 will be approximately one watt (1W). However, if only seven of the ten power amplifiers are turned ‘on’ by the control signal C(t), the total output power of the amplifier module 230 will correspondingly be reduced by approximately thirty percent to seven hundred milliwatts (700 mW). Therefore, where reduction of the amplitude of the recombined output signal Sₒ(t) is necessary, the control signal C(t) is used to turn the appropriate number of power amplifiers ‘on’ or ‘off’ to determine an appropriate total output power from the power module 230 for the purpose of compensating the fixed ratio 13 factor in the recombined output signal Sₒ(t).

Depending on the type of switching amplifier used and the voltage amplitude of the supply voltage supplied, the amplitude of the amplified first and second signal components S₁(t)/S₂(t) may switch between KV_{d} and KV_{d}/β, where K is a constant coefficient associated with the type of switching amplifier. Therefore, depending on the type of switching amplifier used, the recombined output signal Sₒ(t) represented by ninth equations (9) can be modified and represented by tenth equations (10) as follows,

$${s}_{o} ( t ) = \{ \begin{matrix}\frac{{KV}_{d}}{{r}_{max}} {s}_{1} ( t ) + \frac{{KV}_{d}}{{r}_{max}} {s}_{2} ( t ) = \frac{2 {KV}_{d}}{{r}_{max}} r ( t ) {e}^{jφ ( t )} = \frac{2 {KV}_{d}}{{r}_{max}} {s}_{i} ( t ) , & r ( t ) > {r}_{th} \\ \frac{{KV}_{d}}{β {r}_{max}} {s}_{1} ( t ) + \frac{{KV}_{d}}{β {r}_{max}} {s}_{2} ( t ) = \frac{2 {KV}_{d}}{β {r}_{max}} r ( t ) {e}^{jφ ( t )} β = \frac{2 {KV}_{d}}{{r}_{max}} {s}_{i} ( t ) , & r ( t ) \leq {r}_{th}\end{matrix} = \frac{2 {KV}_{d}}{{r}_{max}} {s}_{i} ( t ) \qquad ( 10 )$$

As shown in the ninth and tenth equations (9)/(10), the recombined output signal Sₒ(t) is a linearly amplified output of the input signal Sᵢ(t). Therefore the linear transmitter 200 has a linear input/output response despite nonlinearities that are either inherent in the input signal Sᵢ(t) or introduced during signal processing of the input signal Sᵢ(t) by, for example, the SCS module 210b. Therefore, the linear transmitter 200 is capable of performing linear amplification with substantially high power efficiency. Furthermore, the recombining efficiency at the linear transmitter 200 is substantially improved, as described hereafter with reference to FIG. 2b.

FIG. 2b is a table comparing representative calculated total recombining efficiency ηₜₒₜ values for a conventional LINC transmitter (labelled as “standard LINC system”) and representative calculated total recombining efficiency ηₜₒₜ values for a linear transmitter according to an embodiment of the disclosure (labeled as “proposed system”). Each transmitter operates in accordance with particular typical modulation schemes and a roll-off Root-Raised Cosine (RRC) filter. For the standard LINC system of FIG. 2b, the calculated values shown are identical to the values given for the conventional LINC transmitter of FIG. 1b.

As indicated in FIG. 2b, substantial improvement of over twenty percent (>20%) in the total recombining efficiency ηₜₒₜ of a linear transmitter 200 constructed in accordance with an embodiment of the disclosure, when compared to a conventional LINC transmitter such as that shown in FIG. 1a, can be achieved. As previously described, the selected threshold can be optimized based on signal probability density function. The calculation of the representative recombining efficiency values shown in table 2 is based on an arbitrary or semi-arbitrary condition that the selected threshold signal rₜₕ is half the maximum amplitude level rᵢₙₐₓ, which may not be optimal. Although the calculation as shown in table 2 may not reflect optimal conditions, significant to very significant improvement in the combining efficiency for all signals in table 2 can, nevertheless, be observed. This is especially so for higher order modulations having large PAR.

For example, for a 64-Quadrature amplitude modulation (QAM) signal filtered with a 0.2 roll-off Root-Raised Cosine (RRC) filter, the combining efficiency for the conventional LINC transmitter 100 is 15.7% whereas the combining efficiency of the linear transmitter 200 is 42.2%. There is hence an improvement of 168.8%.

Therefore, assuming 100% power efficiency for the first and second power amplifiers 230a/230b, to produce 2 Watt (W) Radio Frequency (RF) output power, which is typical for wireless mobile devices, a Direct Current (DC) power consumption of 12.7 W will be required for the conventional LINC transmitter 100 while 4.7 W DC power consumption is required for the linear transmitter 200. This provides a savings of 8 W (or a savings of approximately 63%) in DC power consumption. Hence, battery operating lifespan or intervals between battery recharging periods can be increased. Furthermore, device size and weight can be reduced. In addition, for applications such as wireless base stations where high RF output power is required, the benefit of a linear transmitter 200 in accordance with an embodiment of the disclosure being capable of producing a higher RF output power with lower DC power consumption can be readily appreciated.

The linearity of the linear transmitter 200 can be similar or essentially identical to the conventional LINC transmitter 100 as discussed above. As an illustrative example, the similarity in the linearity of a linear transmitter 200 according to an embodiment of the disclosure and that of a conventional LINC transmitter can be verified by simulations of a prototype design simulated at a frequency of 900 MHz, using a simulation program known as “Advanced Design System” (ADS). In the simulations, a class-F power amplifier is designed and used as the final amplification stage in the linear transmitter 200.

FIG. 3 shows a simulated output spectrum of either the amplified first signal component S₁(t) or the amplified second signal component S₂(t) and the recombined output signal Sₒ(t) for a 64-QAM signal with RRC filtering. Linearity of the linear transmitter 200 is also illustrated in FIG. 3.

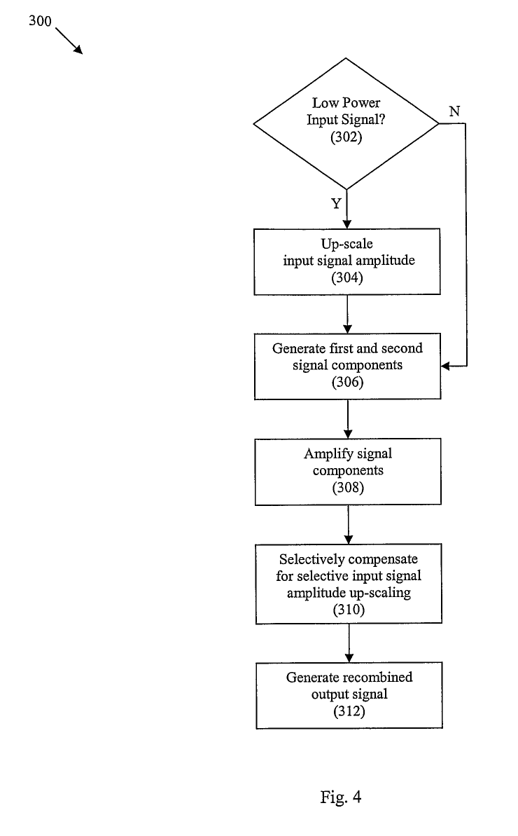

FIG. 4 is a flow diagram of a signal transmission process 300 according to an embodiment of the disclosure. In one embodiment, the process 300 includes process portion 302 that involves determining whether an input signal Sᵢ(t) corresponds to a low input signal power level or condition. Process portion 302 can be performed by comparing the input signal's amplitude with a threshold signal amplitude rₜₕ, in a manner identical or analogous to that described above. In process portion 304, the amplitude of the input signal Sᵢ(t) is up-scaled or multiplied by a factor β if the input signal Sᵢ(t) corresponds to a low power signal, e.g., if input signal's amplitude is below a target minimum or minimum acceptable amplitude rₜₕ. The factor β can be defined or determined in a manner identical or analogous to that previously described. Process portion 306 involves generating a first signal component and a second signal component corresponding to the selectively up-scaled input signal. Process portions 304 and 306 can be performed as a single operational or signal processing sequence by an SCS module 210b such as that described above.

Process portion 308 involves amplifying at least the first signal component, and process portion 310 involves selectively compensating for any selective up-scaling of the input signal's amplitude. In various embodiments, process portions 308 and 310 can be performed simultaneously or essentially simultaneously in a single amplification operation in which at least one set of nonlinear amplifiers is coupled to either a first power supply voltage V or a second power supply voltage V/β based upon whether the amplitude of the input signal Sᵢ(t) was below the threshold signal amplitude rₜₕ Finally, process portion 312 involves generating a recombined output signal in a manner identical or analogous to that described above.

In the foregoing manner, particular linear transmitter embodiments are described for addressing at least one of the previously indicated disadvantages. While features, functions, advantages, and alternatives associated with certain embodiments have been described within the context of those embodiments, other embodiments may also exhibit such advantages, and not all embodiments need necessarily exhibit such advantages to fall within the scope of the disclosure. It will be appreciated that several of the above-disclosed and other structures, features and functions, or alternatives thereof, may be desirably combined into other different devices, systems, or applications. The above-disclosed structures, features and functions, or alternatives thereof, as well as various presently unforeseen or unanticipated alternatives, modifications, variations, or improvements therein that may be subsequently made by those skilled in the art, are intended to be encompassed by the following claims.

1. A signal transmitter comprising:
a control module having a first input coupled to receive an input signal, a second input coupled to receive a threshold signal, and an output configured to provide a control signal;
a signal component separator module having a first input coupled to receive the input signal and a second input coupled to receive the control signal, and having a first output configured to provide a first signal component and a second output configured to provide a second signal component;
a power amplifier module having a first input coupled to the first output of the signal component separator module, a second input coupled to the second output of the signal component separator module, and a control input coupled to the output of the control module, the power amplifier module having a first circuit portion coupled to a first power supply voltage and a second circuit portion coupled to a second power supply voltage, the power amplifier module having a first output and a second output; and
a signal combiner having a first input coupled to the first power amplification module output, a second input coupled to the second power amplifier module output, and an output configured to provide a recombined output signal.

2. The signal transmitter of claim 1, wherein the control module comprises a comparator.

3. The signal transmitter of claim 1, wherein the signal component separator module comprises signal multiplication circuitry configured to selectively multiply the amplitude of an input signal by a factor β in response to the control signal.

4. The signal transmitter of claim 3, wherein the factor β corresponds to the ratio of a maximum input signal amplitude and a lowest acceptable input signal amplitude.

5. The signal transmitter of claim 4, wherein the lowest acceptable input signal amplitude corresponds to the amplitude of the threshold signal.

6. The signal transmitter of claim 4, wherein the first power supply voltage equals V and the second power supply voltage equals V/β.

7. The signal transmitter of claim 6, wherein the power amplifier module comprises:
power supply voltage selection circuitry having a first and a second input respectively coupled to the first and the second power supply voltages, and an output; and
a set of power amplifiers coupled to the output of the power supply voltage selection circuitry and the first and second input of the power amplifier module.

8. The signal transmitter of claim 7, wherein the power supply voltage selection circuitry is configured to selectively couple to one of the first and the second power supply voltages in response to a signal received at the power amplifier module control input.

9. The signal transmitter of claim 1, wherein the power supply amplifier module comprises at least a first nonlinear power amplifier and a second nonlinear power amplifier.

10. The signal transmitter of claim 1, further comprising a converter module having a first input and a second input respectively coupled to the first and second signal component separator module outputs, and first output and a second output respectively coupled to the first and second power amplifier module inputs, the converter module comprising frequency up-conversion circuitry.

11. A signal transmitter comprising:
a comparator having a first input coupled to receive an input signal, a second input coupled to receive a threshold signal, and an output;
a signal component separation module having a first input coupled to receive the input signal, a second input coupled to the output of the comparator, a first output and a second output;
a power amplifier module having a first input and a second input respectively coupled to the first and second signal component separator outputs, a control input coupled to the output of the comparator, and a first output and a second output; and
a signal combiner having a first input and a second input respectively coupled to the first and second power amplifier module outputs, and an output.

12. The signal transmitter of claim 11, wherein the power amplifier module comprises:
a supply voltage selection circuit coupled to a first power supply voltage and a second power supply voltage, the supply voltage selection circuit coupled to the power amplifier module's control input; and
a first and a second nonlinear power amplifier coupled to the supply voltage selection circuit.

13. The signal transmitter of claim 11, wherein the power amplifier module comprises:
a first set of nonlinear amplifiers coupled to a first and a second power supply voltage; and
a second set of nonlinear amplifiers coupled to the first and the second power supply voltage,
wherein the first set of nonlinear amplifiers and the second set of nonlinear amplifiers are each coupled to the power amplifier module's control input.

14. A signal transmission method comprising:
determining whether an input signal amplitude corresponds to a low power condition;
selectively up-scaling the input signal amplitude based upon whether the input signal corresponds to a low power condition;
performing a signal component separation upon the selectively up-scaled input signal to generate a first signal component and a second signal component;
amplifying at least the first signal component;
selectively compensating for the selective up-scaling of the input signal amplitude; and
generating a recombined output signal.

15. The signal transmission method of claim 14, wherein determining whether an input signal amplitude corresponds to a low power condition comprises comparing the input signal amplitude with a threshold signal amplitude.

16. The signal transmission method of claim 14, wherein selectively compensating for the selective up-scaling of the input signal amplitude comprises selecting between circuitry coupled to a first power amplifier supply voltage and circuitry coupled to a second power amplifier supply voltage.

17. The signal transmission method of claim 16, wherein selectively up-scaling the input signal amplitude comprises multiplying the input signal amplitude by a factor β corresponding to a ratio of a maximum input signal amplitude rₘₐₓ and a threshold input signal amplitude rₜₕ, and wherein the first power amplifier supply voltage equals V and the second power amplifier supply voltage equals V/β.

18. The signal transmission method of claim 14, wherein selectively up-scaling the input signal amplitude and performing the signal component separation are performed within a single signal component separator module.

19. The signal transmission method of claim 14, wherein the method is performed in association with a linear amplification by nonlinear components.

20. The signal transmission method of claim 14, further comprising performing a frequency up-conversion operation upon at least one of the first signal component and the second signal component.
